(19) United States
(12) Patent Application Publication
(10) Pub. No.: US 2013/0269976 A1
(43) Pub. Date: Oct. 17, 2013

(54) LEAD-FREE CABLE CONTAINING BISMUTH COMPOUND

(71) Applicants: Sarah Gerretsen, Brownsburg, IN (US); Amalendu Sarkar, Charlotte, NC (US)

(72) Inventors: Amalendu SARKAR, Charlotte, NC (US); Sarah Gerretsen, Brownsburg, IN (US)

(73) Assignee: General Cable Technologies Corporation, Highland Heights, KY (US)

(21) Appl. No.: 13/569,570

(22) Filed: Aug. 8, 2012

Related U.S. Application Data
(60) Provisional application No. 61/521,975, filed on Aug. 10, 2011.

(51) Int. Cl. H01B 3/30

(52) U.S. Cl. CPC H01B 3/307
USPC 174/110 SR; 524/408; 524/302; 524/99; 524/331; 524/305

(57) ABSTRACT

The invention relates to cover (insulation or jacket) compositions for wires or cables having a base polymer and a bismuth compound. The composition contains no significant amount of lead and no added fire retardant.

This application claims the priority of U.S. Provision Patent Application Ser. No. 61/521,975, filed Aug. 10, 2011, which is incorporated herein by reference.

### FIELD OF THE INVENTION

The invention relates to cover (insulation or jacket) compositions for wires or cables having a base polymer and a bismuth compound. The composition contains no significant amount of lead and no added fire retardant.

### BACKGROUND OF THE INVENTION

Typical power cables generally have one or more conductors in a core that is surrounded by several layers that can include: a first polymeric semiconducting shield layer, a polymeric insulating layer, a second polymeric semiconducting shield layer, a metallic tape shield and a polymeric jacket.

Polymeric materials have been utilized in the past as electrical insulating and semiconducting shield materials for power cables. In services or products requiring long-term performance of an electrical cable, such polymeric materials, in addition to having suitable dielectric properties, must be durable. For example, polymeric insulation utilized in building wire, electrical motor or machinery power wires, or underground power transmitting cables, must be durable for safety and economic necessities and practicalities.

One major type of failure that polymeric power cable insulation can undergo is the phenomenon known as treeing. Treeing generally progresses through a dielectric section under electrical stress so that, if visible, its path looks something like a tree. Treeing may occur and progress slowly by periodic partial discharge. It may also occur slowly in the presence of moisture without any partial discharge, or it may occur rapidly as the result of an impulse voltage. Trees may form at the site of a high electrical stress such as contaminants or voids in the body of the insulation-semiconductive screen interface. In solid organic dielectrics, treeing is the most likely mechanism of electrical failures which do not occur catastrophically, but rather appear to be the result of a more lengthy process. In the past, extending the service life of polymeric insulation has been achieved by modifying the polymeric materials by blending, grafting, or copolymerization of silane-based molecules or other additives so that either trees are initiated only at higher voltages than usual or grow more slowly once initiated.

There are two kinds of treeing known as electrical treeing and water treeing. Electrical treeing results from internal electrical discharges that decompose the dielectric. High voltage impulses can produce electrical trees. The damage, which results from the application of high alternating current voltages to the electrode/insulation interfaces, which can contain imperfections, is commercially significant. In this case, very high, localized stress gradients can exist and with sufficient time can lead to initiation and growth of trees. An example of this is a high voltage power cable or connector with a rough interface between the conductor or conductor shield and the primary insulator. The failure mechanism involves actual breakdown of the modular structure of the dielectric material, perhaps by electron bombardment. In the past much of the art has been concerned with the inhibition of electrical trees.

In contrast to electrical treeing, which results from internal electrical discharges that decompose the dielectric, water treeing is the deterioration of a solid dielectric material, which is simultaneously exposed to liquid or vapor and an electric field. Buried power cables are especially vulnerable to water treeing. Water trees initiate from sites of high electrical stress such as rough interfaces, protruding conductive points, voids, or imbedded contaminants, but at lower voltages than that required for electrical trees. In contrast to electrical trees, water trees have the following distinguishing characteristics; (a) the presence of water is essential for their growth; (b) no partial discharge is normally detected during their growth; (c) they can grow for years before reaching a size that may contribute to a breakdown; (d) although slow growing, they are initiated and grow in much lower electrical fields than those required for the development of electrical trees.

Electrical insulation applications are generally divided into low voltage insulation (less than 1 K volts), medium voltage insulation (ranging from 1 K volts to 69 K volts), and high voltage insulation (above 69 K volts). In low voltage applications, for example, electrical cables and applications in the automotive industry treeing is generally not a pervasive problem. For medium-voltage applications, electrical treeing is generally not a pervasive problem and is far less common than water treeing, which frequently is a problem.

The most common polymeric insulators are made from either polyethylene homopolymers or ethylene-propylene elastomers, otherwise known as ethylene-propylene-rubber (EPR) and/or ethylene-propylene-diene ter-polymer (EPDM). Lead, such as lead oxide, has been used as water tree inhibitor and ion scavenger in fileed EPR or EPDM insulation; however, lead is toxic. As such, there remains a need for alternative technology to allow for the removal of hazardous lead from cable insulations. It is also advantageous where the alternative technology offers better flexibility, low dielectric loss, and robust thermal and wet electrical properties.

### BRIEF DESCRIPTION OF THE DRAWINGS

FIG. 1 is a graph showing insulation resistances of compositions A to I over time.

FIG. 2 is a graph showing dissipation factors of compositions A to I over time.

FIG. 3 is a graph showing dielectric constants of compositions A to I over time.

FIG. 4 is a graph showing IRKs for compositions A to I.

FIG. 5 is a graph showing is the AC breakdown strength for compositions A to I.

FIG. 6 is a graph showing the insulation resistances for compositions AD to AL over time.

FIG. 7 is a graph showing the dissipation factors for compositions AD to AL over time.

FIG. 8 is a graph showing the dielectric constants for compositions AD to AL over time.

FIG. 9 is a graph showing the average dissipation factor change percent for compositions AD to AL.

FIG. 10 is a graph showing the average resistance factor change percent for compositions AD to AL.

FIG. 11 is a graph showing the insulation resistances for compositions AA and AG over time.

FIG. 12 is a graph showing the dissipation factors for compositions AA and AG over time.

FIG. 13 is a graph showing the specific inductive capacitances for compositions AA and AG over time.

FIG. 14 is a graph showing the breakdown strengths for compositions AA and AG.

FIG. 15 is a graph showing the insulation resistance constants for compositions AA and AG.

### SUMMARY OF THE INVENTION

Accordingly, the present inventors have unexpectedly discovered that lead in compositions for cable coverings, such as insulations and jackets, can be replaced with bismuth compounds without adversely affecting the performance of the cable. Thus, an object of the present invention provides lead-free and fire retardant-free compositions for cable covering. The lead-free composition contains a base polymer and a bismuth compound, preferably with no added fire retardant. The preferred base polymer is EPR, EPDM, or ethylene acrylic elastomer (AEM); and the preferred bismuth compound is bismuth oxide.

The phrase “lead-free” or “no significant amount of lead” or “no lead” or the like, as used herein, refers to a lead content of less than 1000 parts per million (ppm) based on the total composition, preferably less than 300 ppm, most preferably undetectable using current analytical techniques.

The phrase “fire retardant-free” or “no fire retardant” or “no added fire retardant” or the like, as used herein, refers to the fact that no fire retardant is intentionally added to the composition.

The invention also provides an electric cable containing an electrical conductor surrounded by an insulation. The cover is made from a lead-free composition containing a base polymer and a bismuth compound. The cable can also contain at least one shield layer and jacket as known in the art.

The invention also provides cables using the composition of the present invention and methods of making thereof.

### DETAILED DESCRIPTION OF THE PREFERRED EMBODIMENTS

The base polymer of the present invention can include a variety of compounds. The base polymer can be polyolefins, synthetic rubbers, ethylene vinyl acetate (EVA), polyesters (homopolymers or copolymers), polystyrenes (homopolymers or copolymers), and acrylonitriles (homopolymers or copolymers).

In an embodiment, the base polymer is a polyolefin. Polyolefins, as used herein, are polymers produced from alkenes having the general formula CₙH₂ₙ. In embodiments of the invention the polyolefin is prepared using a conventional Ziegler-Natta catalyst. In preferred embodiments of the invention the polyolefin is selected from the group consisting of a Ziegler-Natta polyethylene, a Ziegler-Natta polypropylene, a copolymer of Ziegler-Natta polyethylene and Ziegler-Natta polypropylene, and a mixture of Ziegler-Natta polyethylene and Ziegler-Natta polypropylene. In more preferred embodiments of the invention the polyolefin is a Ziegler-Natta low density polyethylene (LDPE) or a Ziegler-Natta linear low density polyethylene (LLDPE) or a combination of a Ziegler-Natta LDPE and a Ziegler-Natta LLDPE.

In other embodiments of the invention the polyolefin is prepared using a metallocene catalyst. Alternatively, the polyolefin is a mixture or blend of Ziegler-Natta and metallocene polymers.

The polyolefins utilized in the insulation composition for electric cable in accordance with the invention may also be selected from the group of polymers consisting of ethylene polymerized with at least one co-monomer selected from the group consisting of C₃ to C₂₀ alpha-olefins and C₃ to C₂₀ polyenes. Generally, the alpha-olefins suitable for use in the invention contain in the range of about 3 to about 20 carbon atoms. Preferably, the alpha-olefins contain in the range of about 3 to about 16 carbon atoms, most preferably in the range of about 3 to about 8 carbon atoms. Illustrative non-limiting examples of such alpha-olefins are propylene, 1-butene, 1-pentene, 1-hexene, 1-octene and 1-dodecene.

The polyolefins utilized in the insulation composition for electric cables in accordance with the invention may also be selected from the group of polymers consisting of either ethylene/alpha-olefin copolymers or ethylene/alpha-olefin/diene terpolymers. The polyene utilized in the invention generally has about 3 to about 20 carbon atoms. Preferably, the polyene has in the range of about 4 to about 20 carbon atoms, most preferably in the range of about 4 to about 15 carbon atoms. Preferably, the polyene is a diene, which can be a straight chain, branched chain, or cyclic hydrocarbon diene. Most preferably, the diene is a non conjugated diene. Examples of suitable dienes are straight chain acyclic dienes such as: 1,3-butadiene, 1,4-hexadiene and 1,6-octadiene; branched chain acyclic dienes such as: 5-methyl-1,4-hexadiene, 3,7-dimethyl-1,6-octadiene, 3,7-dimethyl-1,7-octadiene and mixed isomers of dihydro myricene and dihydroocinene; single ring alicyclic dienes such as: 1,3-cyclopentadiene, 1,4-cylcohexadiene, 1,5-cyclooctadiene and 1,5-cyclododecadiene; and multi-ring alicyclic fused and bridged ring dienes such as: tetrahydroindene, methyl tetrahydroindene, dicylcopentadiene, bicyclo-(2,2,1)-hepta-2-5-diene; alkenyl, alkylidene, cycloalkenyl and cycloalkylidene norbornenes such as 5-methylene-2morbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornene. Of the dienes typically used to prepare EPR's, the particularly preferred dienes are 1,4-hexadiene, 5-ethylidene-2-norbornene, 5-vinyllidene-2-norbornene, 5-methylene-2-norbornene and dicyclopentadiene. The especially preferred dienes are 5-ethylidene-2-norbornene and 1,4-hexadiene.

As an additional polymer in the polyolefin composition, a non-metallocene polyolefin may be used having the structural formula of any of the polyolefins or polyolefin copolymers described above. Ethylene-propylene rubber (EPR), polyethylene, polypropylene may all be used in combination with the Zeigler Natta and/or metallocene polymers.

In embodiments of the invention, the polyolefin contains 30% to 50% by weight Zeigler Natta polymer or polymers and 50% to 70% by weight metallocene polymer or polymers The total amount of additives in the treeing resistant “additive package” are from about 0.5% to about 4.0% by weight of said composition, preferably from about 1.0% to about 2.5% by weight of said composition.

A number of catalysts have been found for the polymerization of olefins. Some of the earliest catalysts of this type resulted from the combination of certain transition metal compounds with organometallic compounds of Groups I, II, and III of the Periodic Table. Due to the extensive amounts of early work done by certain research groups many of the catalysts of that type came to be referred to by those skilled in the area as Ziegler-Natta type catalysts. The most commercially successful of the so-called Ziegler-Natta catalysts have heretofore generally been those employing a combination of a transition metal compound and an organoaluminum compound.

Metallocene polymers are produced using a class of highly active olefin catalysts known as metallocenes, which for the purposes of this application are generally defined to contain one or more cyclopentadienyl moiety. The manufacture of metallocene polymers is described in U.S. Pat. No. 6,270,856 to Hendewerk, et al, the disclosure of which is incorporated by reference in its entirety.

Metallocenes are well known especially in the preparation of polyethylene and copolyethylene-alpha-olefins. These catalysts, particularly those based on group IV transition metals, zirconium, titanium and hafnium, show extremely high activity in ethylene polymerization. Various forms of the catalyst system of the metallocene type may be used for polymerization to prepare the polymers used in this invention, including but not limited to those of the homogeneous, supported catalyst type, wherein the catalyst and cocatalyst are together supported or reacted together onto an inert support for polymerization by a gas phase process, high pressure process, or a slurry, solution polymerization process. The metallocene catalysts are also highly flexible in that, by manipulation of the catalyst composition and reaction conditions, they can be made to provide polyolefins with controllable molecular weights from as low as about 200 (useful in applications such as lube-oil additives) to about 1 million or higher, as for example in ultra-high molecular weight linear polyethylene. At the same time, the MWD of the polymers can be controlled from extremely narrow (as in a polydispersity of about 2), to broad (as in a polydispersity of about 8).

Exemplary of the development of these metallocene catalysts for the polymerization of ethylene are U.S. Pat. No. 4,937,299 and EP-A-0 129 368 to Ewen, et al., U.S. Pat. No. 4,808,561 to Welborn, Jr., and U.S. Pat. No. 4,814,310 to Chang, which are all hereby are fully incorporated by reference. Among other things, Ewen, et al. teaches that the structure of the metallocene catalyst includes an alumoxane, formed when water reacts with trialkyl aluminum. The alumoxane complexes with the metallocene compound to form the catalyst. Welborn, Jr. teaches a method of polymerization of ethylene with alpha-olefins and/or diolefins. Chang teaches a method of making a metallocene alumoxane catalyst system utilizing the absorbed water in a silica gel catalyst support. Specific methods for making ethylene/alpha-olefin copolymers, and ethylene/alpha-olefin/diene terpolymers are taught in U.S. Pat. Nos. 4,871,705 and 5,001,205, and in EP-A-0 347 129, respectively, all of which are incorporated herein by reference.

The preferred polyolefins are polyethylene, polybutylene, ethylene-vinyl-acetate, ethylene-propylene (EP) copolymer, ethylene-butene (EB) copolymer, ethylene-octene (EO) copolymer, and other ethylene-α olefin copolymers.

Another base polymer may be synthetic rubbers which are artificial polymeric elastomers that can undergo elastic deformation under stress and still return to its previous size without permanent deformation. The principal synthetic rubbers may be a single polymer or combination of two or more polymers. Non-limiting examples of suitable polymers are EPR, EPDM, carboxylated polyacrylonitrile butadiene, polyisoprene, polychloroprene, and/or polyurethane. Any other elastic polymer/copolymer which may be envisaged as possessing suitable characteristics for the manufacture of a synthetic glove, as described earlier, can be utilised in this invention.

EVA (ethylene vinyl acetate), polyesters (poly(ethylene terephthalate) or PET), polystyrene, and their copolymer are well-known in the art and can be obtained commercially.

The base polymer of the present invention may also crosslinked to form a durable insulation material. Preferably, the polyolefins is crosslinked. The styrenic copolymer may also crosslinked with itself or with the polyolefins. Crosslinking can be accomplished using methods known in the art, including, but not limited to, irradiation, chemical or steam curing, and saline curing. The crosslinking can be accomplished by direct carbon-carbon bond between adjacent polymers or by a linking group.

The compositions of the present invention also contain a bismuth compound, preferably bismuth oxide, also known as bismuth yellow, bismuthous oxide, or dibismuth trioxide. Bismuth oxide is naturally found as the minerals bismite and sphaerobismoite, and is commercially available in various forms including sintered pieces, granules and powder. Other than the minerals, bismuth oxide can also be produced as a byproduct of the smelting of copper and lead ores, or by ignition of bismuth nitrate. Preferably, for the present invention, the bismuth oxide has 99% or higher purity, more preferably 99.99% or higher; moisture level of less than 0.1%, more preferably moisture free; yellow bright or white in color; monoclinic or tetragonal crystal structure; and/or surface area from 8 to 1 m²/g. Bismuth oxide having different particle sizes ranging from the nano rage to greater than 5 micron would work for the present invention; however, the smaller particle sizes, preferably less than 70 microns, are preferred. In a preferred embodiment of the present invention, the bismuth is used in the absence of any added flame retardant. Bismuth has been known to be used in cables as a flame retardant synergist; however, the present invention uses bismuth as a lead replacement rather than as a flame retardant synergist. As such, no flame retardant is needed for the present invention. Generally, flame retardant is any any halogen-containing compound or mixture of compounds which imparts flame resistance to the composition of the present invention. Suitable flame retardants are well-known in the art and include but are not limited to hexahalodiphenyl ethers, octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N,N′)-bis-tetrahalophthalimides, tetrahalophthalic anhydrides, hexahalobenzenes, halogenated indanes, halogenated phosphate esters, halogenated paraffins, halogenated polystyrenes, and polymers of halogenated bisphenol-A and epichlorohydrin, or mixtures thereof. Preferably, the flame retardant is a bromine or chlorine containing compound. In a preferred embodiment, the flame retardant is decabromodiphenyl ether or a mixture of decabromodiphenyl ether with tetrabromobisphenol-A. Those compounds (flame retardants) are preferably not present in the composition of the present invention.

The insulation compositions may optionally be blended with various additives that are generally used in insulated wires or cables, such as an antioxidant, a metal deactivator, a flame retarder, a dispersant, a colorant, a filler, a stabilizer, a peroxide, and/or a lubricant, in the ranges where the object of the present invention is not impaired.

The antioxidant, can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5 bis(1,1 dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-Branched alkyl ester, 2,4-dimethyl-6-t-butylphenol Tetrakis{methylene3-(3′,5′-ditert-butyl-4′-hydroxyphenol)propionate}metha-ne or Tetrakis{methylene3-(3′,5′-ditert-butyl-4′-hydrocinnamate}methane, 1,1,3tris(2-methyl-4hydroxyl5butylphenyl)butane, 2,5,di t-amyl hydroqunone, 1,3,5-tri methyl2,4,6tris(3,5di tert butyl4hydroxybenzyl)benzene, 1,3,5tris(3,5di tert butyl4hydroxybenzyl)isocyanurate, 2,2Methylene-bis-(4-methyl-6-tert butyl-phenol), 6,6′-di-tert-butyl-2,2′-thiodi-p-cresol or 2,2′-thiobis(4-methyl-6-tert-butylphenol), 2,2ethylenebis(4,6-di-t-butylphenol), triethyleneglycol bis{3-(3-t-butyl-4-hydroxy-5methylphenyl)propionate}, 1,3,5tris(4tert butyl3hydroxy-2,6-dimethylbenzyl)-1,3,5-triazine-2,4,6-(1H,3H,5H)trione, 2,2methylenebis{6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, and pentaerythritol-tetrakis(3-lauryl-thiopropionate). The preferred antioxidant is thiodiethylene bis[3-[3,5-di-tert-butyl-4-hydroxyphenyl]propionate which is available commercially as Irganox® 1035.

The metal deactivator, can include, for example, N,N′-bis(3-(3,5-di-t-butyl-4-hydroxyphenyl)propionyl)hydrazine, 3-(N-salicyloyl)amino-1,2,4-triazole, and/or 2,2′-oxamidobis-(ethyl 3-(3,5-di-t-butyl-4-hydroxyphenyl)propionate).

The flame retarder, can include, for example, halogen flame retarders, such as tetrabromobisphenol A (TBA), decabromodiphenyl oxide (DBDPO), octabromodiphenyl ether (OBDPE), hexabromocyclododecane (HBCD), bistribromophenoxyethane (BTBPE), tribromophenol (TBP), ethylenebistetrabromophthalimide, TBA/polycarbonate oligomers, brominated polystyrenes, brominated epoxys, ethylenebispentabromodiphenyl, chlorinated paraffins, and dodecachlorocyclooctane; inorganic flame retarders, such as aluminum hydroxide and magnesium hydroxide; and/or phosphorus flame retarders, such as phosphoric acid compounds, polyphosphoric acid compounds, and red phosphorus compounds.

The filler, can be, for example, carbon, clay (preferably treated or untreated anhydrous aluminum silicate), zinc oxide, tin oxides, magnesium oxide, molybdenum oxides, antimony trioxide, silica (preferably precipitated silica or hydrophilic fumed silica), talc, potassium carbonate, magnesium carbonate, zinc borate, aluminum trihydroxide, and magnesium hydroxide (preferably silane treated magnesium hydroxide).

The stabilizer, can be, but is not limited to, hindered amine light stabilizers (HALS) and/or heat stabilizers. The HALS can include, for example, bis(2,2,6,6-tetramethyl-4-piperidyl)sebaceate; bis(1,2,2,6,6-tetramethyl-4-piperidyl)sebaceate+methyl1,2,2,6,6-tetrameth-yl-4-piperidyl sebaceate; 1,6-Hexanediamine, N,N′-Bis(2,2,6,6-tetramethyl-4-piperidyl)polymer with 2,4,6 trichloro-1,3,5-triazine, reaction products with N-butyl2,2,6,6-tetramethyl-4-piperidinamine; decanedioic acid, Bis(2,2,6,6-tetramethyl-1-(octyloxy)-4-piperidyl)ester, reaction products with 1,1-dimethylethylhydroperoxide and octane; triazine derivatives; butanedioc acid, dimethylester, polymer with 4-hydroxy-2,2,6,6-tetramethyl-1-piperidine ethanol; 1,3,5-triazine-2,4,6-triamine,N,N′″-[1,2-ethane-diyl-bis[[[4,6-bis-[butyl(1,2,2,6,6pentamethyl-4-piperdinyl)amino]-1,3,5-triazine-2-yl]imino-]-3,1-propanediyl]]bis[N′,N″-dibutyl-N′,N″bis(2,2,6,6-tetramethyl-4-pipe-ridyl); and/or bis(1,2,2,6,6-pentamethyl-4-piperidinyl)sebacate; poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]; Benzenepropanoic acid, 3,5-bis(1,1-dimethyl-ethyl)-4-hydroxy-C7-C9 branched alkyl esters and/or Isotridecyl-3-(3,5-di-tert-butyl-4-hydroxyphenyl)propionate. The preferred HALS is bis(1,2,2,6,6-pentamethyl-4-piperidinyl) sebacate commercially available.

The heat stabilizer can be, but is not limited to, 4,6-bis (octylthiomethyl)-o-cresol dioctadecyl 3,3′-thiodipropionate; poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]; Benzenepropanoic acid, 3,5-bis(1,1-dimethyl-ethyl)-4-hydroxy-C7-C9 branched alkyl esters; Isotridecyl-3-(3,5-di-tert-butyl-4-hydroxyphenyl) propionate. If used, the preferred heat stabilizer is 4,6-bis(octylthiomethyl)-o-cresol (Irgastab KV-10); dioctadecyl 3,3′-thiodipropionate and/or poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]].

Peroxides can also be used as a curing agent and can be, but are not limited to, α,α′-bis(tert-butylperoxy)diisopropylbenzene, di(tert-butylperoxyisopropyl)benzene, and dicumyl peroxide, tert-butylcumyl peroxide. In addition to the peroxide or in substitution of the peroxide, other curatives can also be used, including polyols and diamines. Specific examples of other curatives are trifunctional acrylate, trifunctional methacrylate, trimethyloppropane trimethacrylate, and triallyl isocyanurate.

The compositions of the invention can be prepared by blending the base polymer, the bismuth compound, and additives, if any, by use of conventional masticating equipment, for example, a rubber mill, Brabender Mixer, Banbury Mixer, Buss-Ko Kneader, Farrel continuous mixer or twin screw continuous mixer. The additives are preferably premixed before addition to the base polyolefin polymer. Mixing times should be sufficient to obtain homogeneous blends. All of the components of the compositions utilized in the invention are usually blended or compounded together prior to their introduction into an extrusion device from which they are to be extruded onto an electrical conductor.

After the various components of the composition are uniformly admixed and blended together, they are further processed to fabricate the cables of the invention. Prior art methods for fabricating polymer cable insulation or cable jacket are well known, and fabrication of the cable of the invention may generally be accomplished by any of the various extrusion methods.

In a typical extrusion method, an optionally heated conducting core to be coated is pulled through a heated extrusion die, generally a cross-head die, in which a layer of melted polymer is applied to the conducting core. Upon exiting the die, if the polymer is adapted as a thermoset composition, the conducting core with the applied polymer layer may be passed through a heated vulcanizing section, or continuous vulcanizing section and then a cooling section, generally an elongated cooling bath, to cool. Multiple polymer layers may be applied by consecutive extrusion steps in which an additional layer is added in each step, or with the proper type of die, multiple polymer layers may be applied simultaneously.

The conductor of the invention may generally comprise any suitable electrically conducting material, although generally electrically conducting metals are utilized. Preferably, the metals utilized are copper or aluminum. In power transmission, aluminum conductor/steel reinforcement (ACSR) cable, aluminum conductor/aluminum reinforcement (ACAR) cable, or aluminum cable is generally preferred.

Without further description, it is believed that one of ordinary skill in the art can, using the preceding description and the following illustrative examples, make and utilize the compositions of the present invention and practice the claimed methods. The following examples are given to illustrate the present invention. It should be understood that the invention is not to be limited to the specific conditions or details described in those examples.

### EXAMPLE 1

### Insulation for Low Voltage Industrial Cable

Several compositions were made in accordance to the present inventions for use in low voltage utility cable. The make-up of those compositions and are shown in Table 1.

TABLE 1
(units are in phr)

| | A | B | C | D | E | F | G | H | I |
|---|---|---|---|---|---|---|---|---|---|
| EO Copolymer | 92.00 | 92.00 | 92.00 | 92.00 | 92.00 | 92.00 | 92.00 | 92.00 | 92.00 |
| EVA Copolymer | 8.00 | 8.00 | 8.00 | 8.00 | 8.00 | 8.00 | 8.00 | 8.00 | 8.00 |
| Antioxident | 1.25 | 1.25 | 1.25 | 1.25 | 1.25 | 1.25 | 1.25 | 1.25 | 1.25 |
| Filler | 20.00 | 20.00 | 20.00 | 20.00 | 20.00 | 20.00 | 20.00 | 20.00 | 20.00 |
| FR | 180.00 | 180.00 | 180.00 | 180.00 | 180.00 | 180.00 | 180.00 | 180.00 | 180.00 |
| Lead Stabilizer | 7.50 | | | | | | | | |
| Bismuth Oxide 1* | | 3.00 | 6.00 | | | | | | |
| Bismuth Oxide 2** | | | | 3.00 | 6.00 | | | | |
| Bismuth Oxide 3*** | | | | | | 3.00 | 6.00 | | |
| Bismuth Oxide 4**** | | | | | | | | 3.00 | 6.00 |
| Peroxide | 1.60 | 1.60 | 1.60 | 1.60 | 1.60 | 1.60 | 1.60 | 1.60 | 1.60 |
| TOTAL | 310.35 | 305.85 | 308.85 | 305.85 | 308.85 | 305.85 | 308.85 | 305.85 | 308.85 |

*Bismuth oxide 1 has diameters of >70 microns
**Bismuth oxide 2 has submicron diameters
***Bismuth oxide 3 has submicron diameters and is yellow
****Bismuth oxide 4 has diameters between bismuth oxide 1 and bismuth oxide 2.

Table 2 shows the physical properties of compositions A to I. Tensile and elongation are measured in accordance to ASTM D412 (2010) or D638 (2010) using a Zwick universal testing machine or an Instron Tester. MDR (Moving Die Rheometer) values are measured with an Alpha Technologies Production MDR. MH is maximum torque measured at full cure. ML is minimum torque recorded. T05 and T90 are torques measured at 5% cure and at 90% cure.

TABLE 2

| | A | B | C | D | E | F | G | H | I |
|---|---|---|---|---|---|---|---|---|---|
| Initial Tensile (Psi) | 1481 | 1782 | 1731 | 1765 | 1669 | 1679 | 1669 | 1808 | 1729 |
| Initial % Elongation | 496 | 514 | 522 | 452 | 444 | 501 | 558 | 572 | 442 |
| Aged 168 hr 136° C. | | | | | | | | | |
| % Tensile Retained | 95 | 98 | 96 | 98 | 100 | 97 | 93 | 84 | 98 |
| % Elongation Retained | 83 | 88 | 87 | 90 | 94 | 91 | 95 | 94 | 93 |

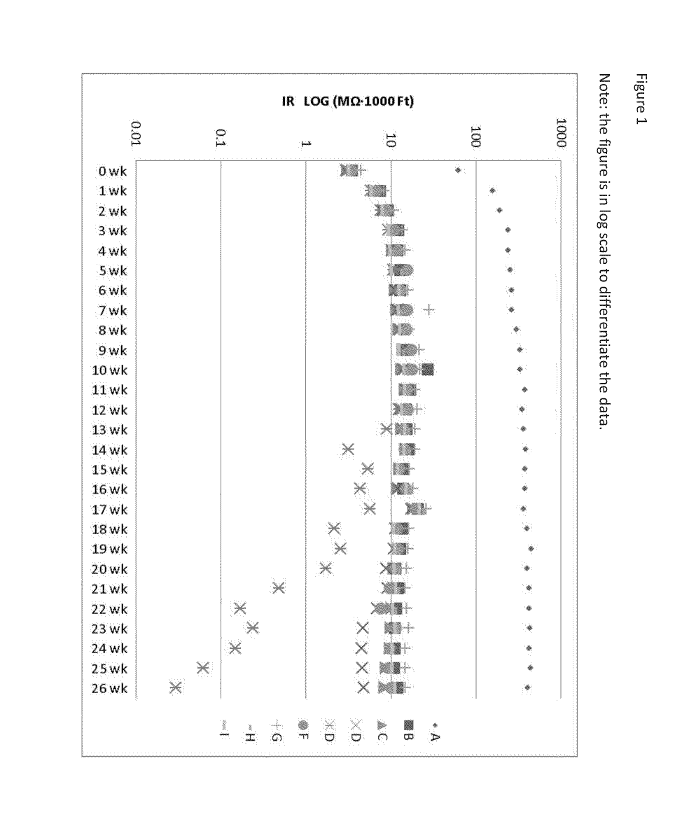

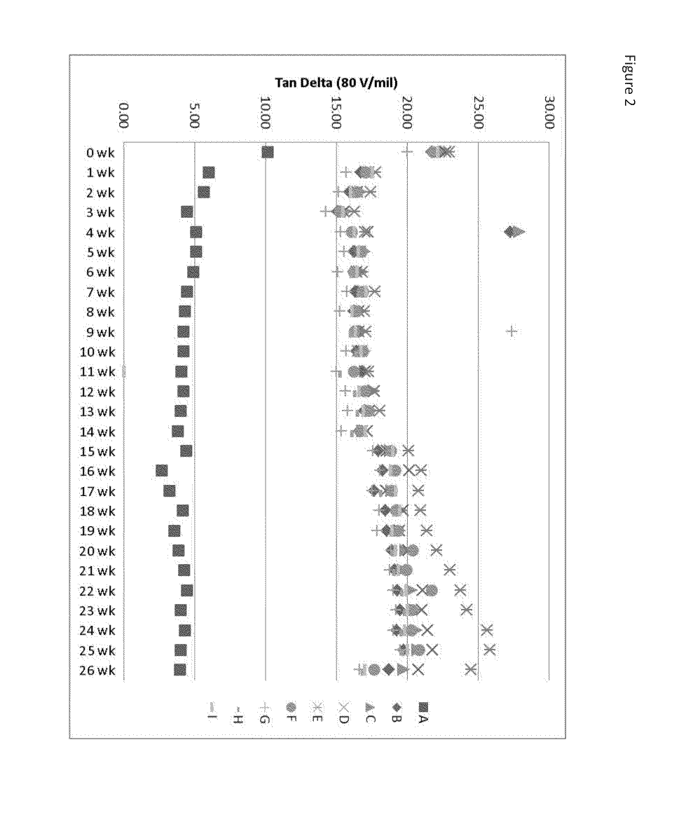

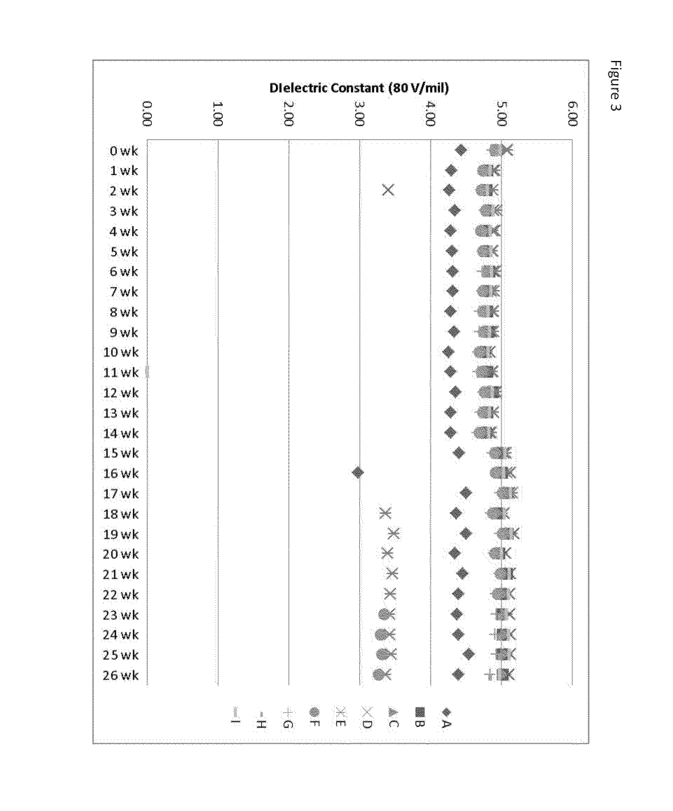

FIGS. 1, 2, and 3 show the insulation resistances, dissipation factors, and dielectric constants, respectively, for compositions A to I. Here, A #14AWG copper wire with 45 mils on insulation is submerged in 90° C. with a 2.2 kV AC voltage applied for ageing. Insulation resistance (IR) was measured in accordance to UL 2556 (2010) using a 1868A megaohmmeter. Dissipation factors (DF) and dielectric constant (DC) were measured in accordance to UL 2556 (2010) using Tettex 2218A Capacitance and Dissipation Factor Test set at 80 V/mil. Dielectric constant was measured in accordance to ASTM D150 (2011).

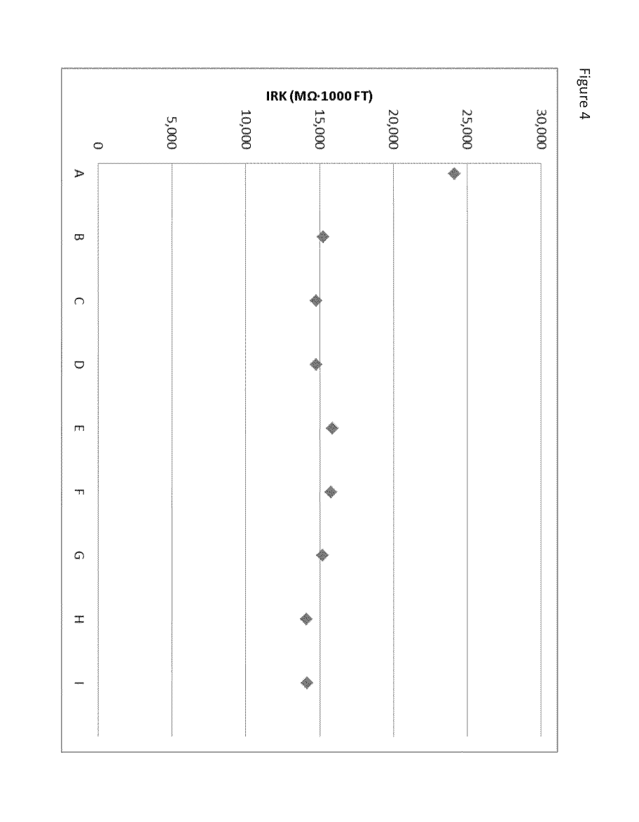

FIG. 4 shows IRK (IR measured at 15.6° C. water temperature) for the cables. A megaohmmeter gives this value at 500V DC. For the present application, higher values are desired.

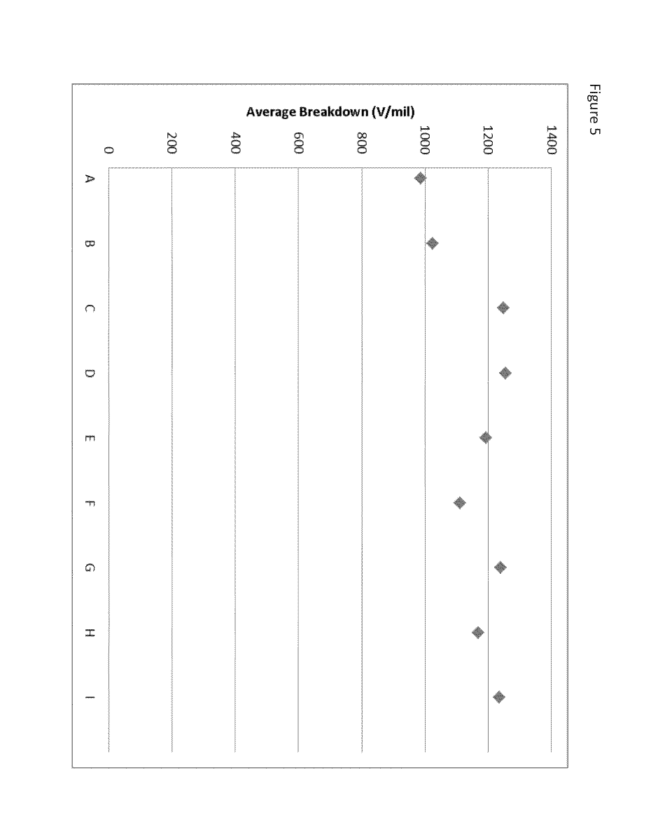

FIG. 5 shows the AC breakdown strength. AC voltage is applied with a ramp rate of 1 kV/s until failure of the insulation occurs. For the present application, higher values are desired.

### EXAMPLE 2

### Insulation for Medium Voltage Utility Cable

Several compositions were made in accordance to the present inventions for use in medium voltage utility cable. The make-up of those compositions and are shown in Table 3.

TABLE 3
(units are in phr)

| | AD | AI | AJ | AK | AL |
|---|---|---|---|---|---|
| EPDM | 46.00 | 46.00 | 46.00 | 46.00 | 46.00 |
| EB copolymer | 44.00 | 44.00 | 44.00 | 44.00 | 44.00 |
| PE | 10.00 | 10.00 | 10.00 | 10.00 | 10.00 |
| Filler | 50.00 | 50.00 | 50.00 | 50.00 | 50.00 |
| Phenolic | 1.00 | 1.00 | 1.00 | 1.00 | 1.00 |
| Antioxident | | | | | |
| UV | 0.75 | 0.75 | 0.75 | 0.75 | 0.75 |
| Bismuth Oxide 1 | | 3.00 | | | |
| (>70 micron) | | | | | |
| Bismuth Oxide 2 | | | 3.00 | | |
| (Submicron) | | | | | |
| Bismuth Oxide 3 | | | | 3.00 | |
| (Yellow submicron) | | | | | |
| Bismuth Oxide 4 | | | | | 3.00 |
| (<70 and >submicron) | | | | | |
| Peroxide | 3.00 | 3.00 | 3.00 | 3.00 | 3.00 |
| TOTAL | 154.75 | 157.75 | 157.75 | 157.75 | 157.75 |

Table 4 shows the physical properties of compositions AD to AL after aging at different temperatures.

TABLE 4

| | AD | AI | AJ | AK | AL |
|---|---|---|---|---|---|
| Initial Tensile (Psi) | 1765 | 1729 | 1685 | 1718 | 1704 |
| Initial % Elongation | 452 | 442 | 423 | 439 | 448 |
| Aged 168 hr 136° C. | | | | | |
| % Tensile Retained | 98 | 98 | 102 | 99 | 102 |
| % Elongation Retained | 90 | 93 | 99 | 93 | 94 |

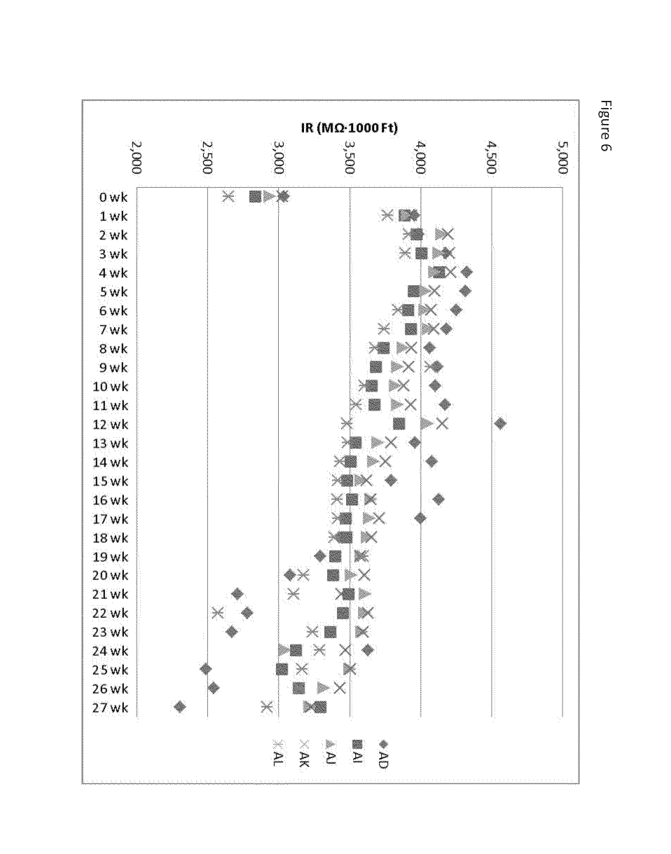

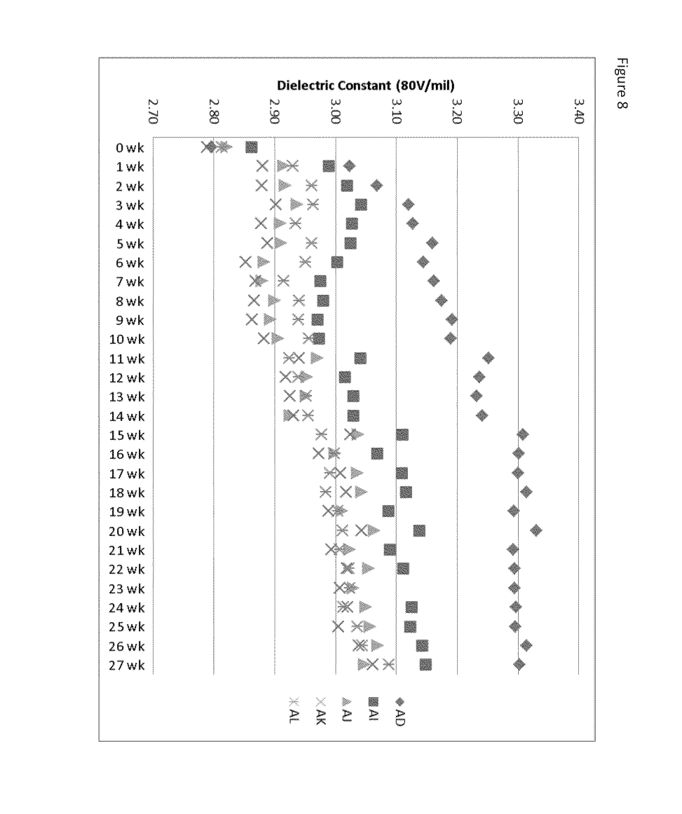

FIGS. 6, 7, and 8 show the insulation resistances, dissipation factors, and dielectric constants, respectively, for compositions AD, AI, AJ, AK and AL.

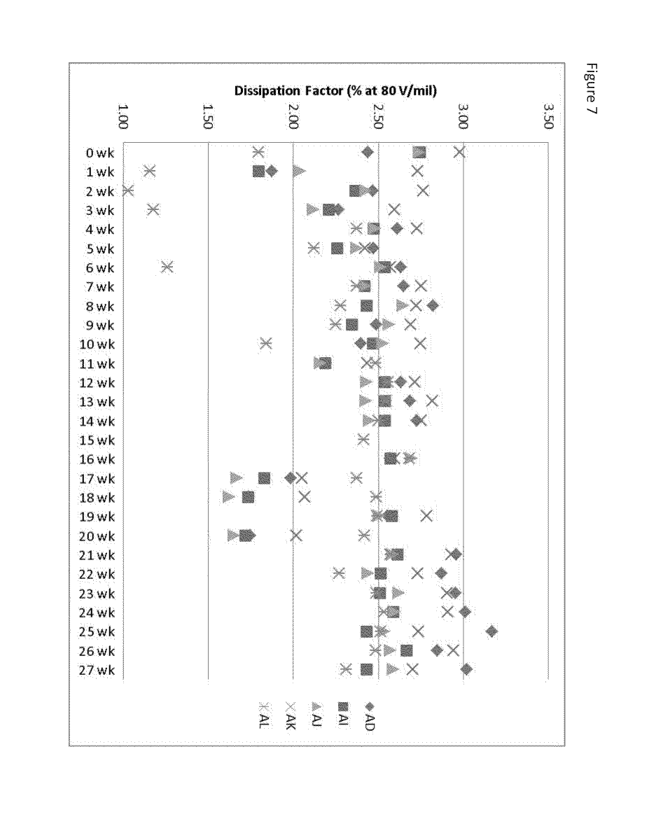

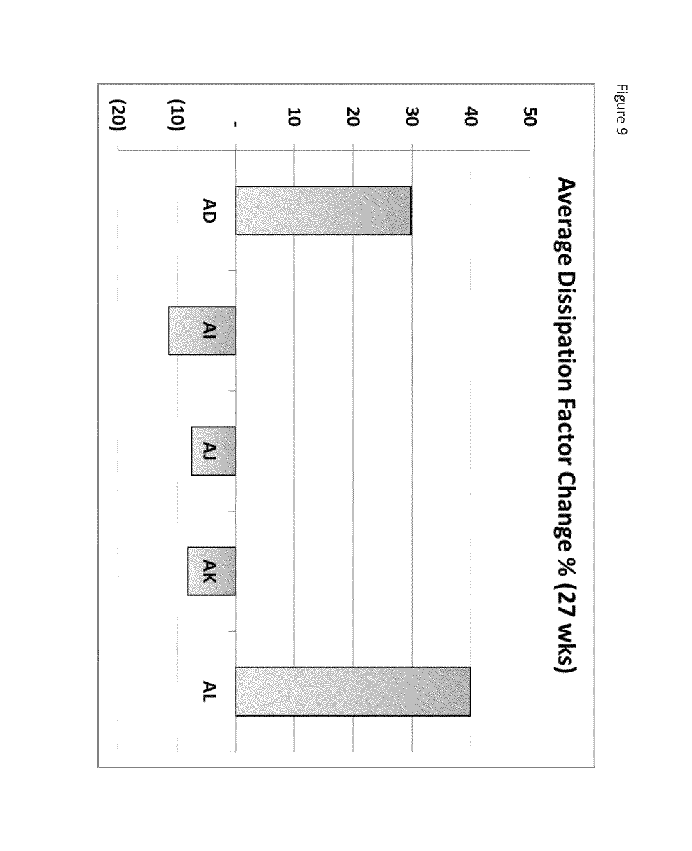

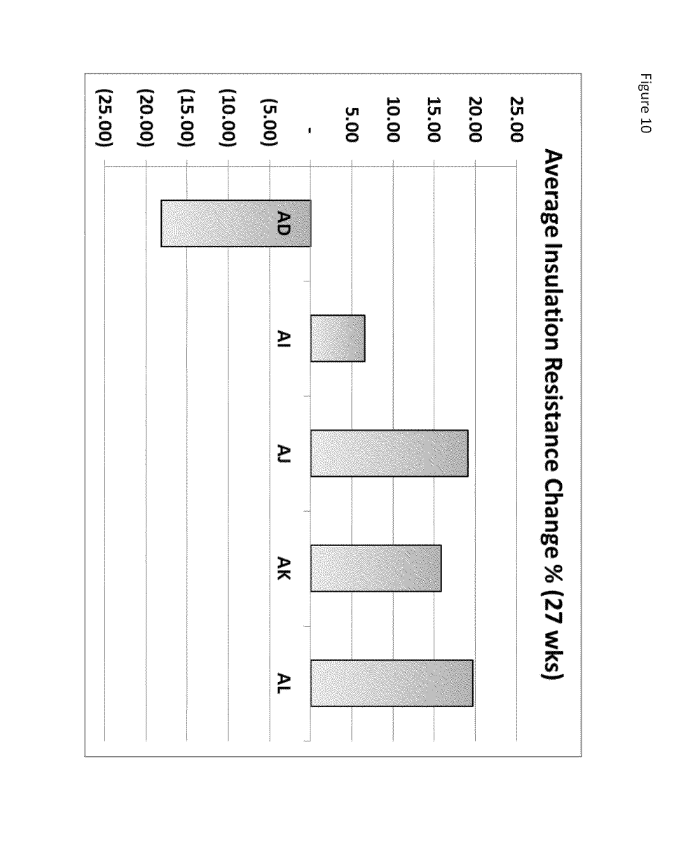

FIGS. 9 and 10 show the average dissipation factor change percent (from FIG. 7) and the average resistance factor change percent (from FIG. 6), respectively, for compositions AD to AL. Note that for dissipation factor change (FIG. 9), the lower the better; and for insulation resistance change (FIG. 10), the higher the better.

### EXAMPLE 3

### Comparison of Two Lead Substitutes

Two compositions were made as shown in Table 5 (unit are in phr) to compare HALS and bismuth oxide as lead replacement:

TABLE 5

| | AA (phr) | AG (phr) |
|---|---|---|
| EB Resin (Engage 7447) | 90.00 | 90.00 |
| Low density polyethylene | 20.00 | 20.00 |
| (DYNH-1) | | |
| Silane treated Kaolin Clay | 50.00 | 50.00 |
| (Polyfil WC) | | |
| Hydroquinoline antioxidant | 0.75 | 0.75 |
| (Agerite Resin D) | | |
| Petroleum hydrocarbon (CS 2037) | 5.00 | 5.00 |
| Vinyl silane masterbatch | 0.83 | 0.83 |
| (EF(A172)-50) | | |
| HALS stabilizer (Tinuvin 622LD) | 0.75 | |
| Zinc Oxide (Azo 66) | 5.00 | 5.00 |
| Bismuth Oxide (Bismuth Oxide | | 3.00 |
| (Submicron)) | | |

Table 6 shows the physical properties of compositions AA and AG after aging at different temperatures.

TABLE 6

| | AA | AG |
|---|---|---|
| Initial Tensile (PSI) | 1610.00 | 1699 |
| Initial % Elongation | 569.00 | 561 |
| Aged 168 hours at 150° C. | | |
| % Tensile Retained | 94.00 | 88 |
| % Elongation Retained | 98.00 | 91 |

Table 7 shows the accelerated electrical requirements of AA and AG. A #14 AWG copper wire with 45 mils of insulation is exposed to 90° C. water for two weeks. Capacitance and dissipation factor measurements are taken periodically. The test requirements are described by Table 10-5 in ICEA S-94-649-2004

TABLE 7

| | Accelerated Electrical | | |
|---|---|---|---|
| | Requirements in Water | | Requirement |
| | AA | AG | (EPR Class III) |
| SIC after 24 hours in water | 2.93 | 2.92 | maximum |
| | | | 4.0 |
| Increase in capacitance | 1.24 | −1.36 | maximum |
| (1 to 14 days) (%) | | | 3.5 |
| Increase in capacitance | 2.36 | 0.51 | maximum |
| (7 to 14 days) (%) | | | 1.6 |
| Stability Factor | 0.52 | 0.16 | maximum |
| | | | 1.0 |
| Alternate to stability factor | 0.59 | 0.16 | maximum |
| | | | 0.5 |

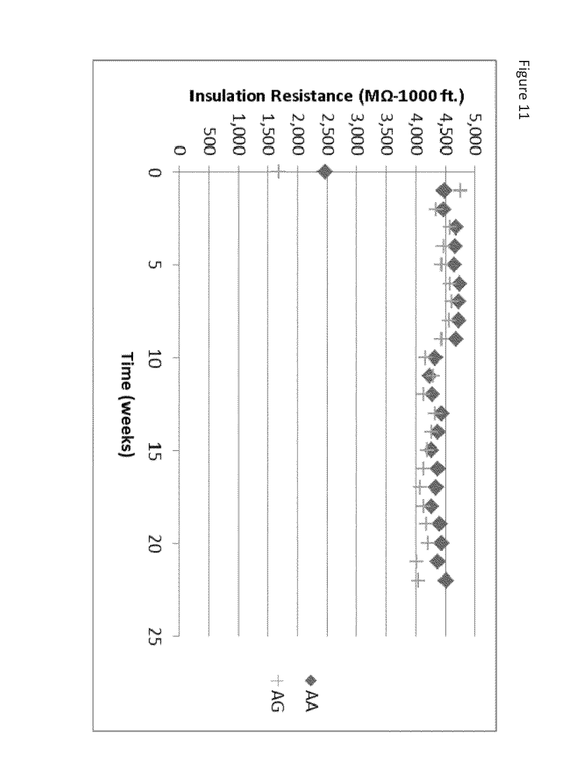

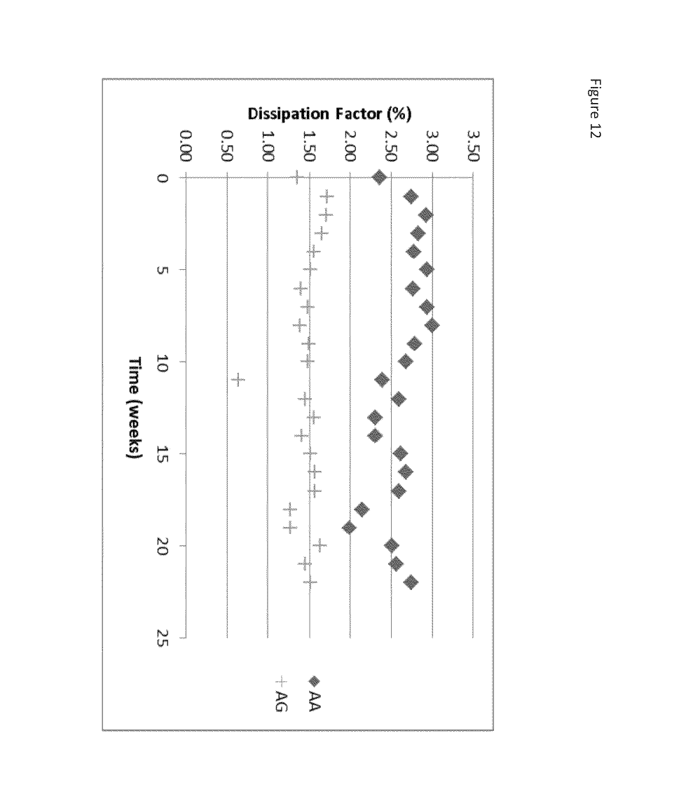

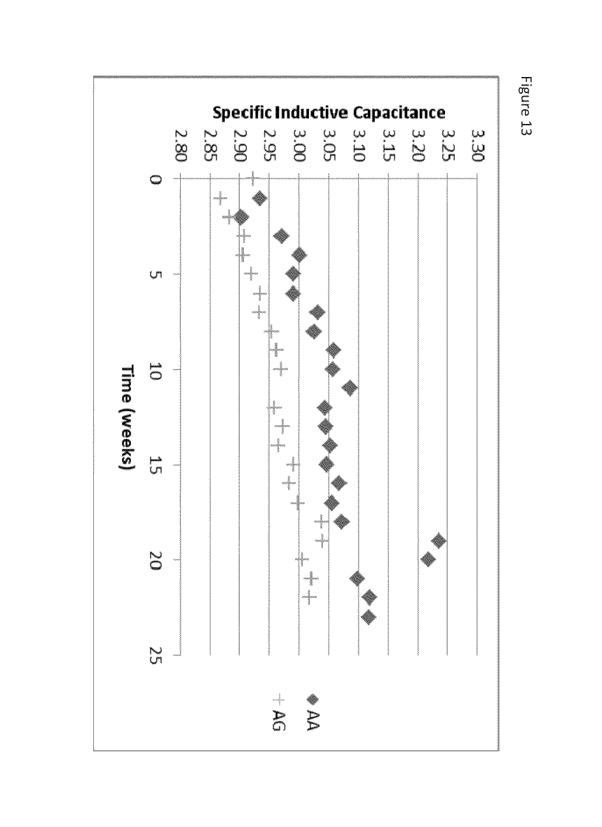

FIGS. 11, 12, and 13 show the insulation resistances, dissipation factors, and specific inductive capacitance (SIC), respectively, for compositions AA and AG, respectively. Specific inductive capacitance was measured in accordance to ASTM D150 (2011).

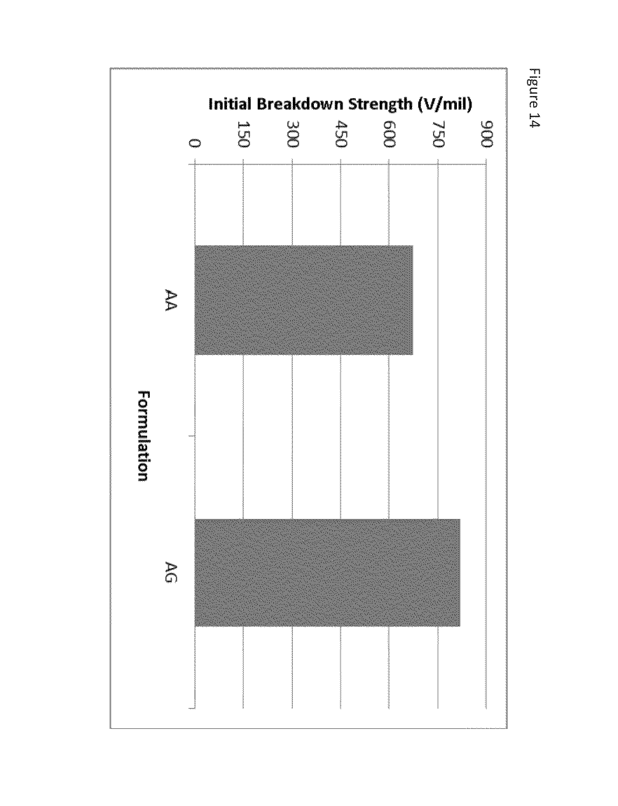

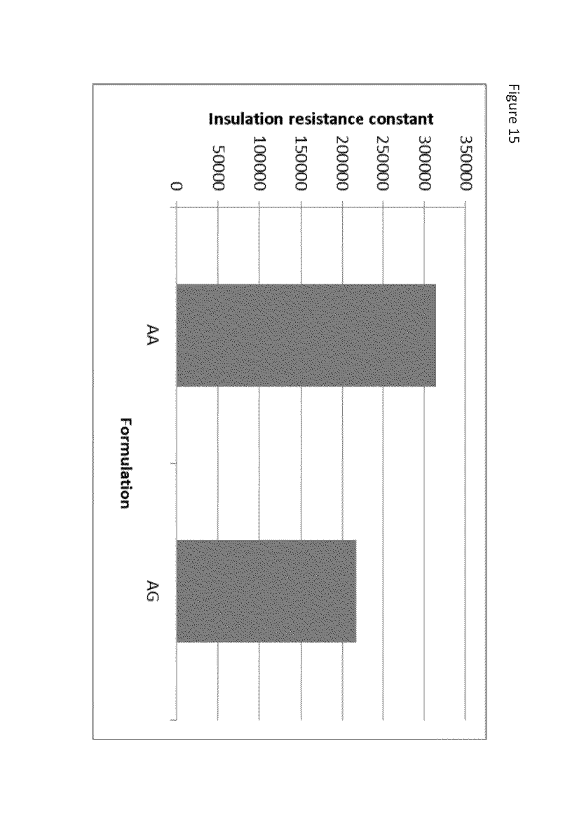

FIGS. 14 and 15 show the breakdown strength and the insulation resistance constant (IRK) for compositions AA and AG, respectively. Breakdown measurement was taken on a #14 AWG copper wire with 45 mils of insulation, where the wire was exposed to AC voltage increasing at a rate of 1 kV/s until insulation failure occurs. A higher breakdown strength is desired. Insulation resistance was conducted on #14AWG copper wires with 45 mils on insulation. The wires were maintained at 15.6° C. while the insulation resistance was measured. ICEA S-94-649-2004 4.3.2.4 requires insulation to have a minimum IRK of 20,000 MΩ-1000 ft.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A composition comprising a base polymer and a bismuth compound, wherein the composition contains no lead and no fire retardant.

2. The composition of claim 1, wherein the bismuth compound is bismuth oxide.

3. The composition of claim 1, further comprising at least one additive.

4. The composition of claim 3, wherein the at least one additive is selected from the group consisting of an antioxidant, a metal deactivator, a flame retarder, a dispersant, a colorant, a filler, a stabilizer, a peroxide, and a lubricant.

5. The composition of claim 1, wherein the antioxidant is thiodiethylene bis[3-[3,5-di-tert-butyl-4-hydroxyphenyl]propionate.

6. The composition of claim 1, wherein the stabilizer is bis (1,2,2,6,6-pentamethyl-4-piperidinyl)sebacate, 4,6-bis(octylthiomethyl)-o-cresol, or dioctadecyl 3,3′-thiodipropionate.

7. The composition of claim 1, wherein the base polymer is a polyolefin, a synthetic rubber, ethylene vinyl acetate (EVA), a polyester, a polystyrene, or an acrylonitrile.

8. The composition of claim 1, wherein the base polymer is a polystyrene/polyolefin copolymer.

9. The composition of claim 1, base polymer is ethylene-propylene-rubber (EPR) and/or ethylene-propylene-diene monomer rubber (EPDM).

10. The composition of claim 1, wherein the base polymer is crosslinked.

11. A cable comprising a conductor and a covering made of the material of claim 1.

12. The cable of claim 10, wherein the covering is an insulation or a jacket.

13. The cable of claim 10, wherein the bismuth compound is bismuth oxide.

14. The cable of claim 10, further comprising at least one additive.

15. The cable of claim 12, wherein the at least one additive is selected from the group consisting of an antioxidant, a metal deactivator, a flame retarder, a dispersant, a colorant, a filler, a stabilizer, a peroxide, and a lubricant.

16. The cable of claim 10, wherein the base polymer is a polyolefin, a synthetic rubber, ethylene vinyl acetate (EVA), a polyester, a polystyrene, or an acrylonitrile.

17. A method for making a cable comprising the step of
a. providing a conductor; and
b. covering the conductor with the material of claim 1.

18. The method of claim 17, wherein step b is used to make an insulation or a jacket.

19. The method of claim 17, wherein the bismuth compound is bismuth oxide.

20. The method of claim 19, wherein the base polymer is a polyolefin, a synthetic rubber, ethylene vinyl acetate (EVA), a polyester, a polystyrene, or an acrylonitrile.
